(19) United States
(12) Patent Application Publication
(10) Pub. No.: US 2012/0018258 A1
(43) Pub. Date: Jan. 26, 2012

(54) RIM BRAKE

(75) Inventors: Erick AUGER, Jonquiere (CA); Martin PORTELANCE, Chicoutimi (CA); Martin BLAIS, Laterriere (CA)

(73) Assignee: NEVIO DESIGN INC., Jonquiere (CA)

(21) Appl. No.: 13/184,938

(22) Filed: Jul. 18, 2011

Related U.S. Application Data
(60) Provisional application No. 61/366,389, filed on Jul. 21, 2010.

(51) Int. Cl. B62L 1/10; B62L 1/12

(52) U.S. Cl. 188/24.22

(57) ABSTRACT

A rim brake of the side-pull caliper type having two arms pivotally mounted about a common pivoting axis which is laterally offset from the wheel reference plane.

### CROSS-REFERENCE TO RELATED APPLICATIONS

Priority is claimed of U.S. provisional application 61/366,689, filed Jul. 22, 2010, the contents of which are hereby incorporated by reference.

### FIELD

The improvements generally relate to the field of bicycle brakes, and more particularly rim brakes of the side-pull caliper type.

### BACKGROUND

In recent years, much emphasis has been put on reducing the weight of bicycle components. This can represent a significant challenge, especially when dealing with components having such performance, durability and safety expectations as bicycle brakes.

In the case of rim brakes, several approaches are currently commercialized. These approaches each have characteristic strengths and weaknesses. For instance, a traditional centered simple pivot side pull rim brake can have a lower weight and costs, but the trade-off is limited braking strength which is a consequence of the limited lever-arm distance between the side pull cable and cable housing receiving portions on the two arms and the centrally positioned single pivot. Another well known approach is the double pivot side pull rim brake (see U.S. Pat. No. 4,852,698) which uses a support arm having two pivots, one centrally disposed to which one of the brake arms is pivotally mounted, and another one laterally offset to which the other brake arm is connected. Because the two pivots are offset from one another, the braking forces are affected by the difference in the lever arm distance. This is counterbalanced by an abutment which transfers a portion of the force applied to the brake arm having the longer lever arm distance to the other brake arm. The double pivot side pull rim brake is widespread and offers significantly more braking strength than the traditional simple pivot side pull rim brake, but has a significantly greater weight particularly where bushings and bearings are used at the two pivots, due to the relatively high weight of these components.

Henceforth, although the former approaches have been satisfactory to a certain degree, there remained room for improvement.

### SUMMARY

In accordance with one aspect, there is provided a rim brake of the side-pull caliper type having the two arms pivotally connected to one another at a common pivot axis, being characterized in that the common pivot axis is laterally offset on a side of the wheel reference plane opposite to the cable and cable housing receiving portions.

In accordance with another aspect, there is provided a rim brake of the side-pull caliper type having the two arms pivotally connected to one another at a common pivot axis being characterized in that the common pivot axis is inclined relative to a mounting axis of the rim brake.

In accordance with another aspect, there is provided a rim brake comprising a wheel reference plane having a first side and a second side, a first arm having an operating portion on a first side of the reference plane and a brake shoe receiving portion; a second arm being pivotally mounted to the first arm around a pivot axis located on the second side of the reference plane, the second arm having an operating portion on the first side of the reference plane and a brake shoe receiving portion being in opposition with the brake shoe receiving portion of the first arm around the pivot axis, on opposite sides of the reference plane, to exert a compressive braking force upon actuation of the operating portions of the first arm and second arm.

In accordance with another aspect, there is provided a bicycle brake comprising a wheel reference plane, a first arm having a cable housing receiving portion and a first brake shoe receiving portion extending downwardly relative the cable housing receiving portion, and an extension extending laterally relative the cable housing and crossing the bicycle wheel reference plane to a first pivot; a second arm having a second pivot pivotally connected to the first pivot about a common pivot axis, a second extension extending laterally from the second pivot across the bicycle wheel reference plane to a cable receiving portion spaced from the cable housing receiving portion, and a second brake shoe receiving portion extending downwardly from the second pivot and being in opposition with the first brake shoe receiving portion, wherein the pivot axis is laterally offset from the bicycle wheel reference plane and the brake shoe receiving portions are brought toward one another around the common pivot axis when the cable receiving portion is moved toward the cable housing receiving portion, further comprising a return spring biasing the brake shoe receiving portions away from one another.

In accordance with another aspect, there is provided a bicycle brake having two arms pivotally mounted to one another along a pivot axis, the two pivoting arms being collectively mountable to a bicycle frame along a mounting axis, wherein the pivot axis is inclined relative to the mounting axis.

In accordance with another aspect, there is provided a rim brake of the side-pull caliper type having two arms pivotally mounted about a common pivoting axis which is laterally offset from the wheel reference plane.

### DESCRIPTION OF THE FIGURES

In the figures,

FIG. 1 is an oblique view of a rim brake;

FIG. 2 is a front view of the rim brake of FIG. 1;

FIG. 3 is a rear view of the rim brake of FIG. 1;

FIG. 4 is a side view of the rim brake of FIG. 1; and

FIG. 5 is an exploded view of the rim brake of FIG. 1.

### DETAILED DESCRIPTION

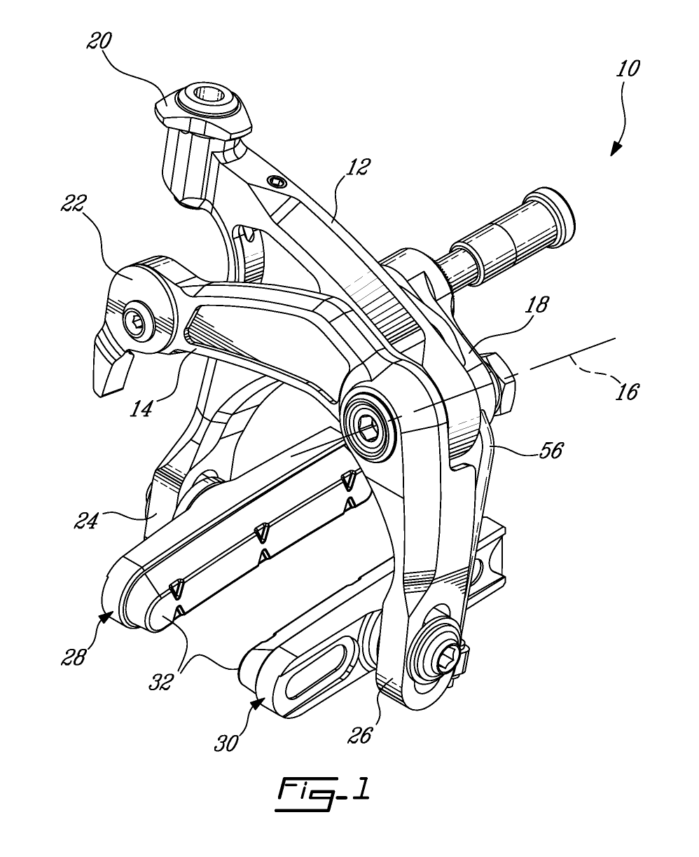

FIG. 1 shows an example of an improved rim brake 10 of the side pull caliper type. The brake 10 can be seen to generally include two arms, referred to herein as a first arm 12 and a second arm 14, pivotally mounted to each other about a common pivot axis 16. In this particular case, the brake 10 is mounted to a vehicle frame (not shown) via a support arm 18 which is to be mounted fixedly relative to the frame but which allows the pivoting movement of both the first arm 12 and the second arm 14. The first arm 12 has a cable housing receiving portion 20, for securely receiving a cable housing of the bicycle braking system (not shown), whereas the second arm 14 has a cable receiving portion 22 for securely receiving the cable extending out the cable housing (not shown). Each one of the first arm 12 and the second arm 14 has a corresponding brake shoe receiving portion 24, 26 to which a corresponding brake shoe 28, 30 bearing a brake pad 32 is mounted.

During operation, a user activates a brake lever typically located on a handle of a bicycle (not shown), which has the effect of retracting the cable within the cable housing. This pulls the cable receiving portion 22 of the second arm 14 toward the cable housing receiving portion 20 of the first arm 12, pivoting the arms 12, 14 around the pivot axis 16, and bringing the brake pads 32 toward one another against a rim of the wheel (not shown) to apply thereto a braking force by friction. After braking, the first arm 12 and second arm 14 are pivoted back into their default position by a biasing force, and the brake pads 32 are thus moved out from interference with the rim.

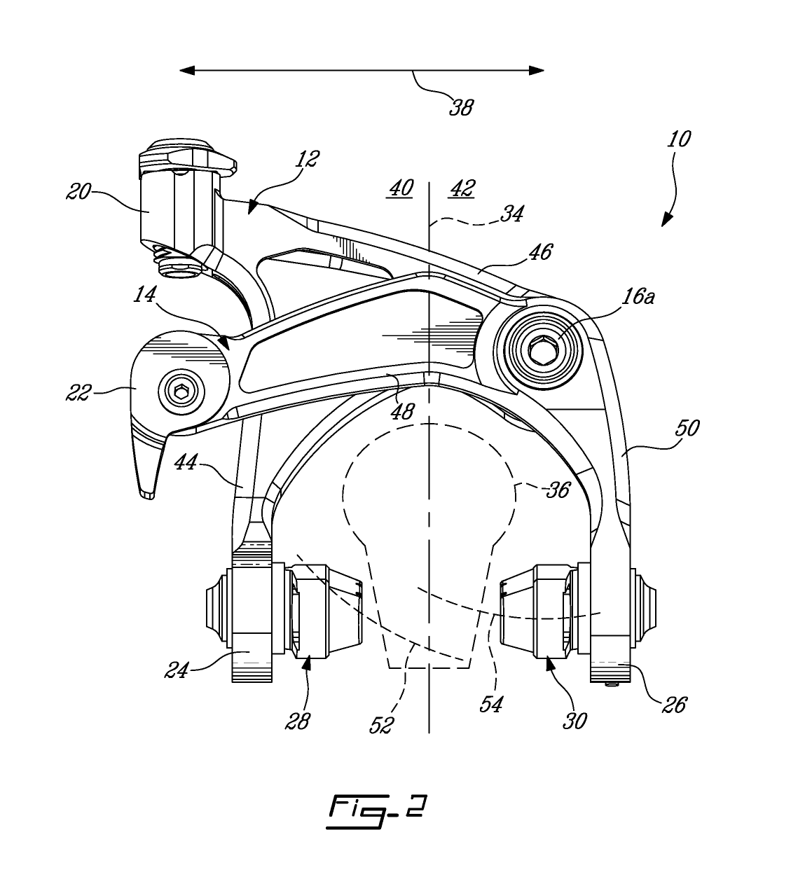

Turning to FIG. 2, the shape of the first arm 12 and second arm 14 is shown in greater detail, in reference with a reference plane 34 which corresponds to the center plane of the wheel 36 of the bicycle and with the wheel 36 of the bicycle which is also schematically shown. It can be seen for instance that both the cable housing receiving portion 20 and the cable receiving portion 22 are positioned above the brake shoe receiving portions 24, 26 (with reference to a bicycle standing vertically), and are also located laterally completely to one side 40 of the brake 10 to offer significant lever arm distance 38 with the common pivot 16a, which is located on the other side 42 of the bicycle wheel reference plane 34. The common pivot 16a is also positioned above the brake shoes 28, 30 using the same reference.

More particularly, the first arm 12 has the cable housing receiving portion 20 at the uppermost and sidemost end of the brake 10, has a downwardly depending extension 44 leading to the brake shoe receiving portion 24, and a laterally projecting extension 46 crossing the reference plane 34 and leading to the common pivot 16a. Both the cable housing receiving portion 20 and the brake shoe receiving portion 24 are on the one side 40 of the reference plane 34, whereas the pivot is located on the other side 42 of the reference plane 34.

The second arm 14 has an extension 48 laterally projecting from the pivot 16a and crossing the reference plane 34 to the cable receiving portion 22, and an other extension 50 depending downwardly from the common pivot 16a to the brake shoe receiving portion 26.

The brake shoe receiving portions 24, 26 of the first arm 12 and second arm 14 can be seen to be transversally aligned with one another, and in opposition with each other, so as to exert a compressive force on the rim when the cable is activated.

One of the main challenges in achieving a functional embodiment of a single offset pivot brake as described above and illustrated is the selection of the location of the pivot axis. Logically, one would tend to position the common pivot as far as feasible from the cable housing and cable receiving portions, and tend to position the common pivot closer to the brake shoe receiving portions in order to increase the lever arm and consequently increase the braking power. However, offsetting the single pivot from the center to the side has the trade-off of affecting the path of the brake shoes when the brake is operated. To illustrate this, the pivotal path 52 of the first brake shoe 28 and the pivotal path 54 of the second brake shoe 30 around the common pivot 16a are schematically depicted in FIG. 2. One can see that because of the difference of distance between the first brake shoe 28 and the pivot 16a, and between the second brake shoe 30 and the pivot 16a, which is caused by the offsetting of the pivot 16a, the first and second brake shoes 28, 30 do not travel along an arc-shaped path having the same radius. This affects the transversal alignment of the brake shoes as braking is applied.

When first considering a pivot location which was further offset laterally, and closer to the second brake shoe, the effect of transversal misalignment was so important that the design was discarded as being non-functional. The idea of offsetting the pivot as a whole was at that point almost dropped as non-feasible. It was recalled that there is a practical limit to the requirement of braking power for a bicycle, since past a given amount of braking power, the bicycle wheel will likely start to skid. Henceforth, experimentation was then undertaken to limit the lever arm in order to diminish the misalignment effect caused by offsetting the pivot too much and see if there was a zone there the misalignment effect would be tolerable. The pivot was also moved upwardly away from the brake shoe, which further tended to equilibrate the travelling paths of the two brake shoes. It was also recalled that the brake shoes typically do not travel more than 2-3 mm during normal use, which contributes to limiting the misalignment effect.

Trial and error using computer-assisted simulation led to selecting a pivot location corresponding to the one shown in the attached figures where a satisfactory compromise was achieved between increasing the lever arm/braking power and reducing the misalignment of the brake pads along their limited movement span during normal use. Further, computer assisted virtual testing led to discover that with the illustrated configuration, with the common pivot 16a positioned above the second brake shoe 30, and being laterally aligned with the cable receiving portion 22, and with other proportions illustrated, a braking force comparable to that achievable using a traditional double pivot rim brake could be achieved with a single offset pivot, and the elimination of the second pivot could lead to significant weight reduction, particularly given the fact that pivots are relatively heavy components.

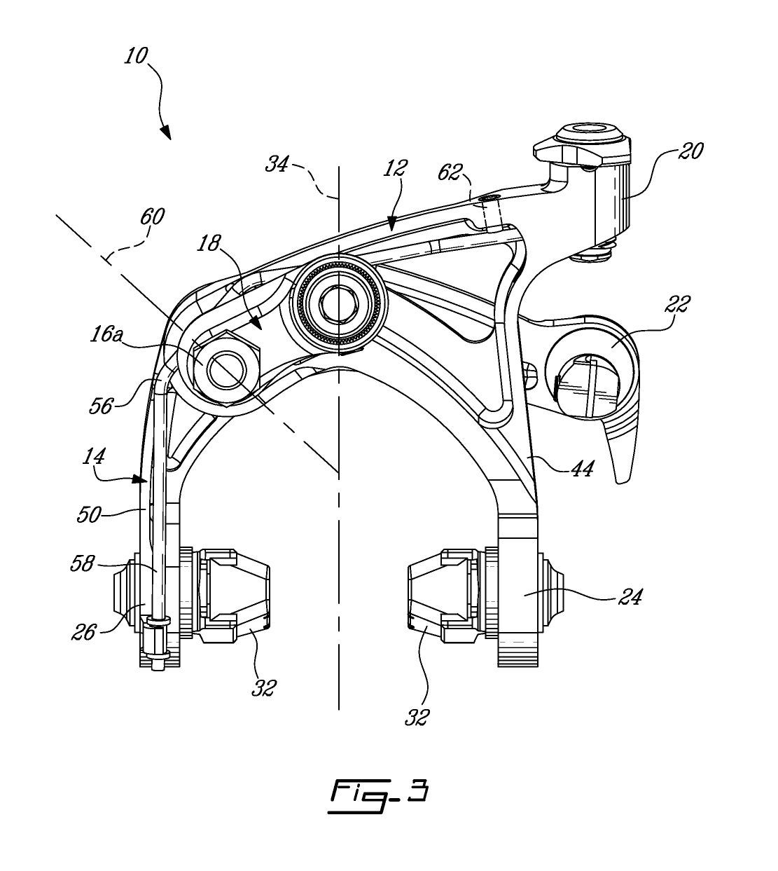

Referring now to FIG. 3, another challenge in offsetting the pivot 16a resided in finding a solution to apply the bias, or returning force, to pivot the arms 12, 14 back into an open state subsequently to the application of braking. In a traditional centered simple pivot brake, a spring can be applied onto each symmetrically depending portion of the arms to apply an equal force on each one. In the case of an offset pivot 16a as shown and described herein, the depending extensions 44, 50 leading to shoe receiving portions 24, 26 do not extend symmetrically from the pivot 16a. One solution was found, where the spring 56 remained centered relative the pivot 16, and has one end 58 received near the brake shoe receiving portion 26 of the second arm 14, and the other end 60 received by the first arm 12, near the cable housing receiving portion 20, 22. In this manner, the spring 56 remained substantially symmetrical relative to the offset pivot 16a but along an inclined plane 60 rather than with the wheel reference plane 34. Further, a spring adjuster 62, simply consisting of a set screw in this case, was provided in one of the arms 12 (it can alternately be provide in the other one or both), to allow fine-tuning of the spring tension, which affects the default position of the brake pads 32 relative the wheel.

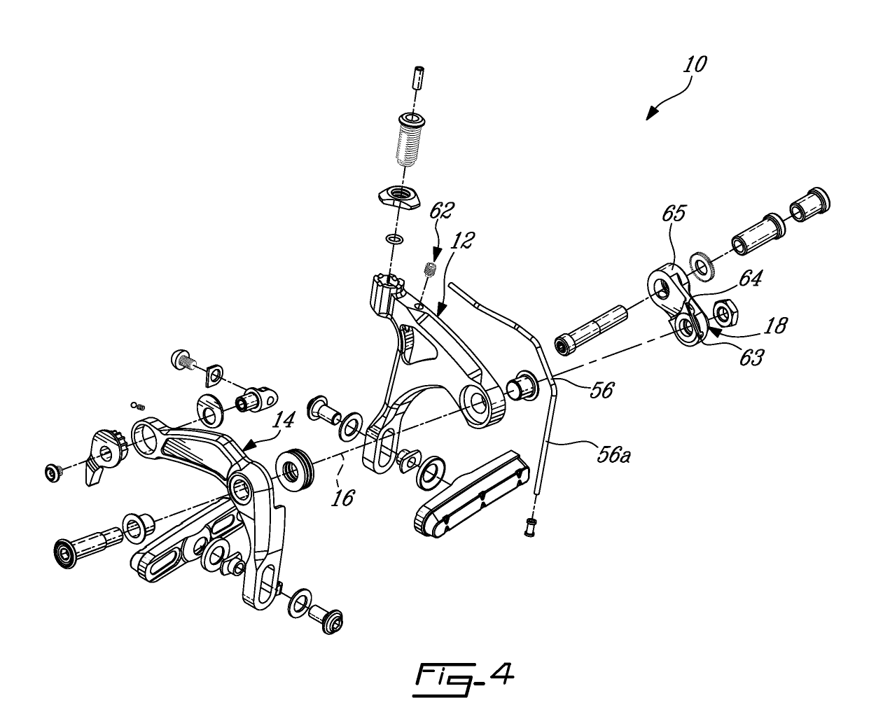

To detail this particular embodiment further, the spring 56 is firmly held in position relative the support arm 18. Henceforth, although both the first arm 12 and second arm 14 can pivot independently relative to the support arm 68 about the pivot 16a, the spring 56 firmly held with the support arm 18 tends to push them apart and thereby limits the pivoting liberty of both arms 12, 14 relative to the support arm 56. The details of the particular spring 56 used in this embodiment, and the means by which it is held, is visible more clearly in the exploded view provided in FIG. 4, where it can be seen that the spring is a shaped wire 56a in this case which is trapped in a groove 64 defined in the support arm 18. During installation, the assembled brake 10 is mounted to the frame of the bicycle via the support arm 18, whence care is applied to give the support arm 18 a satisfactory orientation. Thereafter, the fine tuning of the orientation of the first arm 12 and second arm 14 relative the support arm 18 around the pivot axis 16 is done using the adjuster 62 provided. The support arm 18 can be said to have a first end 63 receiving the first and second arms 12, 14 and a second end 65 for mounting to the bicycle frame.

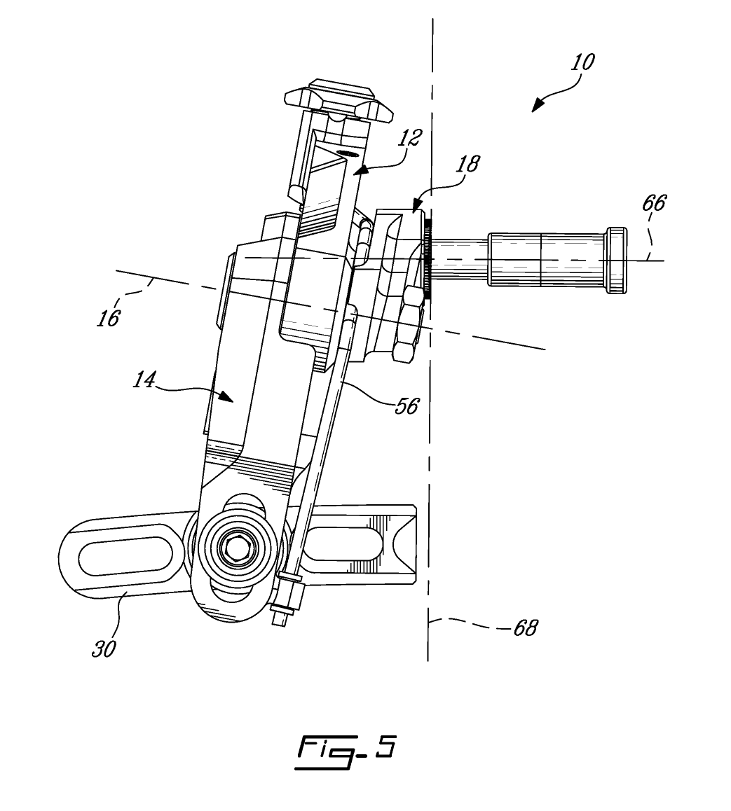

Referring now to FIG. 5, a second significant improvement will now be described. As shown, the brake 10 in this particular embodiment can be mounted to a frame of the bicycle along a reference mounting axis 66. Former side-pull caliper brakes pivot about an axis which coincides with this reference mounting axis 66. There is a consideration when designing a brake 10 that the brake shoes 30 longitudinally project from the fork (which is schematized here with a fork reference plane 68). A traditional approach to achieving this desired longitudinal offsetting of the brake shoes 30, some former sidepull caliper brakes used a bushing of some sort which protruded along the mounting axis 66 to space the generally vertically oriented arms (which extended generally normally from the mounting axis 66) away from fork reference plane 68, thereby offsetting the brake shoes longitudinally. As shown in the embodiment illustrated herein, the pivoting axis 16 which is offset laterally from the mounting axis 66 via the support arm 18, is inclined compared to the mounting axis, by about 10 degrees in this case, and is in a plane which is parallel to the wheel reference plane 34 (see FIG. 2). This inclination allows the arms 12, 14, which extend generally normally from the pivot axis 16, to also be inclined off the vertical and cover a satisfactory longitudinal distance to allow the brake shoes 30 to satisfactorily clear the fork plane 68. This removes or reduces the need for this longitudinal distance to be covered by a bushing or other weighty means, and can thus contribute to reduce the overall weight of the brake 10.

It will be understood that the embodiment described herein and illustrated is exemplary only, and that variants are intended to be encompassed within the scope. For instance, in an alternate embodiment, the brake can be substantially a mirror image of the one illustrated. The position of the pivot axis can depart from the exact one illustrated herein. The inclination of the pivoting axis, which is of about 10° in the embodiment illustrated, can vary and can even be omitted in alternate embodiments, given that it is optional. The arms can be made of aluminium, or alternately of magnesium or other suitable materials. Further, although the depicted embodiment is mounted to a point coinciding with the wheel reference plane, it can be mounted to a point offset from the wheel reference plane in alternate embodiments. Also, it will be noted that the position of the cable receiving portion and cable housing receiving portion can also vary, and even be inversed, in alternate embodiments, and these can even be entirely omitted in an alternate embodiment which would be operable by other means than a cable. The cable receiving portion and cable housing receiving portion can thus be generally referred to as operating portions.

As can be seen therefore, the example described above and illustrated are intended to be exemplary only. The scope is indicated by the appended claims.

1. A rim brake comprising a wheel reference plane having a first side and a second side, a first arm having an operating portion on a first side of the reference plane and a brake shoe receiving portion; a second arm being pivotally mounted to the first arm around a pivot axis located on the second side of the reference plane, the second arm having an operating portion on the first side of the reference plane and a brake shoe receiving portion being in opposition with the brake shoe receiving portion of the first arm around the pivot axis, on opposite sides of the reference plane, to exert a compressive braking force upon actuation of the operating portions of the first arm and second arm.

2. The rim brake of claim 1 further comprising a support arm, the support arm having a first end pivotally receiving both the first arm and second arm at the pivot axis, and a second end connectable to a bicycle frame.

3. The rim brake of claim 2 wherein the support arm is connectable to the bicycle frame along a mounting axis coinciding with the reference plane.

4. The rim brake of claim 2 erg wherein the pivot axis is inclined relative to the mounting axis, along an offset plane parallel to the reference plane.

5. The rim brake of claim 4 wherein the brake shoe receiving portions are lengthwisely advanced relative the operating portions to clear the bicycle frame.

6. The rim brake of claim 1 further comprising a return spring having a first end received by the first arm and a second end received by the second arm and pivotally biasing the first arm and second arm in a manner spacing the brake shoe receiving portions away from one another.

7. The rim brake of claim 6 wherein the return spring is symmetrical about an inclined plane passing across the pivot axis.

8. The rim brake of claim 6 wherein the first end is received near the operating portion of the first arm and the second end is received near the brake shoe receiving portion of the second arm.

9. The rim brake of claim 6 further comprising at least one spring adjuster adjustable to precisely modify the position of one of the first end and the second end of the return spring relative to the corresponding arm.

10. The rim brake of claim 1 wherein the first arm is pivotally biased relative the second arm in a direction spacing the brake shoe receiving portions away from one another.

11. The rim brake of claim 1 wherein the operating portion of the first arm is a cable housing receiving portion and the operating portion of the second arm is a cable receiving portion.

12. The rim brake of claim 1 wherein each one of the brake receiving portions further comprises a corresponding brake shoe having a break pad mounted thereto.

13. A bicycle brake comprising a wheel reference plane, a first arm having a cable housing receiving portion and a first brake shoe receiving portion extending downwardly relative the cable housing receiving portion, and an extension extending laterally relative the cable housing and crossing the bicycle wheel reference plane to a first pivot; a second arm having a second pivot pivotally connected to the first pivot about a common pivot axis, a second extension extending laterally from the second pivot across the bicycle wheel reference plane to a cable receiving portion spaced from the cable housing receiving portion, and a second brake shoe receiving portion extending downwardly from the second pivot and being in opposition with the first brake shoe receiving portion, wherein the pivot axis is laterally offset from the bicycle wheel reference plane and the brake shoe receiving portions are brought toward one another around the common pivot axis when the cable receiving portion is moved toward the cable housing receiving portion, further comprising a return spring biasing the brake shoe receiving portions away from one another.

14. The bicycle brake of claim 13 further comprising a support arm, the support arm having a first end pivotally receiving both the first arm and second arm at the pivot axis, and a second end connectable to a bicycle frame along a mounting axis coinciding with the reference plane, wherein the pivot axis is inclined relative to the mounting axis, along an offset plane parallel to the reference plane.

15. A bicycle brake having two arms pivotally mounted to one another along a pivot axis, the two pivoting arms being collectively mountable to a bicycle frame along a mounting axis, wherein the pivot axis is inclined relative to the mounting axis.
